(19) United States
(12) Patent Application Publication
(10) Pub. No.: US 2024/0224904 A1
(43) Pub. Date: Jul. 11, 2024

(54) Device and method for providing plants integrated beneficial structural support, nutrients, chemicals, and biomass

(71) Applicant: Robert John Fourqurean, Washington, DC (US)

(72) Inventor: Robert John Fourqurean, Washington, DC (US)

(21) Appl. No.: 18/151,450

(22) Filed: Jan. 8, 2023

(51) Int. Cl. A01G 29/00; A01G 9/12

(52) U.S. Cl. CPC A01G 29/00; A01G 9/122

(57) ABSTRACT

The present invention comprises of a novel plant support and supplement supplying device consisting of a support structure and integrated degradable composite, capable of supplying concentrated amounts of supplements and beneficial structural support to the stem/trunk, leaves, flowers, and fruits of plants. The support structure can be made of any rigid material capable of supporting its own weight and weight of the intended plant. The support structure serves as a point of attachment the user can utilize to secure the plant to. The degradable composite may be made of any range of beneficial nutrients, chemicals, and biological components that would help the plant grow. In preferred embodiments, multiple vertical support structures and degradable composites can be assembled in a set to supply a larger area of structural support and greater capacity to deliver beneficial supplements.

### BACKGROUND

### Field of the Invention

The present invention relates to a novel device that supplements the growing environment for individual plants. More particularly, the invention relates to a single use, fully integrated device capable of providing beneficial structural support, nutrients, chemicals, and microorganisms related to the added growth and health of plants.

### Support

When tending to farm, potted, and garden plants, there are many ways an individual can supplement and encourage the support and advanced growth of their plants.

Well known methods can include the application of pesticides and fertilizers. Fertilizers are applied to add supplemental nutrients to the soil. Effective fertilizers are made and designed so plants can easily absorb and incorporate their nutrients into their biological structures allowing them to grow faster and produce higher yields. Pesticides are used to combat and ward off pests that would cause harm to the plant. Many insects and other organisms use cultivated crops as a food source. It is estimated that pests contribute to the loss of between 20-40 percent of all global crop production. The application of chemical and organic pesticides helps to ward off pests keeping plants healthy and alive.

The addition of other biological components can be used to advance plant growth. Mycorrhizae powder, or the spores of mycorrhizal fungi can be added to soil to benefit plant growth. Mycorrhizal fungi and plants develop a symbiotic relationship within the soil where the fungi develop intricate filament structures within plant roots. The fungi live within the roots and draw nutrients into the root systems of plants that the plant would not be able to access otherwise. Together the plants and fungi live and work together benefiting off the others existence with minimal cost to themselves.

Some plants benefit from the use of structural supports. Very young, tall, top-heavy, and plants grown in windy locations often need and rely on structural supports to help them grow. Support structures are used to provide support the plant would noticeably benefit from if otherwise not provided, or to mimic structures the plants have evolutionally developed to rely on to grow properly. Examples of plants that would benefit or need support are tomato plants that produce enough fruit and plant matter at the top of the plant that it is in danger of collapsing without added support or vine like plants that require a host structure to grow on.

Structural supports provided to plants generally take the form of stakes, cages, nets, and other like objects however they are not integrated to provide any additional growth supplements in the form of fertilizers, pesticides, or microorganisms.

Conventional methods of fertilizer and pesticide application to plants and crops have led to adverse ecological problems. Excess fertilizer and pesticide runoff leach into watersheds and aquifers poisoning the water ways. The over-use and over spray of fertilizers over large farm areas or small home gardens can infect waterways causing problematic eutrophication events. Eutrophication events are when excess nutrients from the land runoff into a lake or other body of water causing dense growth of plant life and death of animal life due to lack of oxygen. The runoff of fertilizers can ultimately cause the death of whole aquatic communities impacted by their local farming and gardening communities.

Pesticide runoff can cause additional problems. Pesticides are chemicals meant to poison, kill, or ward off wildlife. The overuse and excess of these chemicals can contaminate water sources through runoff destroying habitats by the poisoning of fish and wildlife. Other problems that can occur are the contamination of our food sources if animals absorb these chemicals and are consumed.

Current ways pesticides and fertilizers are administered are in the spraying or coating of entire fields or gardens in a non-concentrated manner leading to excess runoff. When applied to fields in such a way, it is easier for runoff to occur and chemicals be wasted, providing a need for the chemicals and nutrients to be applied underground efficiently. Current devices exist that insert concentrated amounts of pesticides and fertilizers underground but are not also fully incorporated into a plant support structure.

Contemporary farming and gardening practices use all these different components. However, most of the time they are used separately and in a non-integrated way. Current devices have been developed that can supply the various growing supplements of support, fertilizers, pesticides, and microorganisms in unison, however where they fail is in their over complexity and maintenance requirements. Current devices while intended to be re-usable, require to be disassembled and loose practicality over time as constant maintenance is expected and required. This maintenance includes having to refill fertilizer storages and other like properties requiring the purchase and obtainment of different materials at different times. Over time these contraptions can be expected to wear out in the environment in which they operate requiring the reinvestment in a new multipart device.

A practical need exists for a device that can be used as an all-purpose vehicle for efficiently supplying plant support, nutrients, chemicals, and microorganisms at one time in a low maintenance manner. More so, there is a need for the device to be capable of supplying the chemicals, nutrients, and microorganisms contained in a concentrated way underground that optimizes plant growth while minimizing runoff. Finally, there is a need for the device to be easily consumable, made up of one inseparable unit, and easily ignored as it is intended to stay in the ground throughout crucial periods of the plant's life.

### BRIEF SUMMARY OF THE INVENTION

The present invention seeks to provide a solution to these problems by providing a self-anchoring plant support structure with an incorporated composite of either fertilizer, pesticides, microorganism spores, and any additional chemicals and compounds used to enhance plant growth, that has been molded and attached to and is as a whole inseparable, unless by destructive means, from the base of the support structure. The composite can consist of any of the aforementioned materials individually or in any combination, mixture, or grouping, and will be attached to the base of the support structure that is driven underground and will degrade over time releasing concentrated amounts of its contents to be slowly taken up and incorporated by the roots of the plant. The section of the incorporated support structure that extends above ground will serve as a point of attachment the user can affix their preferred plant to using any attachment method desired including but not limited to using string, rope, wire, and other like materials and methods. The support structure will be made of a material resistant to the environment during the growing plant's life span, allowing it to exist as a support structure long after the composite has completely degraded and been incorporated by the plant.

### BRIEF DESCRIPTION OF THE DRAWINGS

Some embodiments of the present invention and its application method are illustrated as an example and are not limited by the figures of the accompanying drawings, in which like references may indicate similar elements and in which:

FIG. 1-FIG. 1 depicts a standalone example of the integrated plant structure and supplement device

FIG. 2-FIG. 2 depicts an example of how the device can be used. The device is depicted next to a plant, with the bulbus component of the device (which is meant to consist of a degradable composite of various amounts of fertilizer, systemic pesticides, microorganism colonies, and any additional chemicals and compounds used to enhance plant growth) residing below the soil line, in close enough proximity to the roots so the plant can efficiently absorb and interact with its contents. The device is depicted to support itself in the soil, protruding vertically out of the soil, providing a point of attachment for the plant to be secured through either natural or artificial means. The purpose of the protruding structure is to provide structural assistance to the plant's stem/trunk, leaves, branches, flowers, and fruits.

FIGS. 3A-C-FIGS. 3A-C depict cross sections of three possible non-limiting examples of how the degradable composite would be geometrically incorporated onto the base of the support structure, reducing its ability to separate from the support structure before it has completely degraded into the surrounding soil. FIG. 3A shows the composite having been fixed to the base of the support structure without any purposeful modifications having been made to the support structure that would enhance the composite's grip to the support structure. FIG. 3B shows a support structure with purposefully modified grooves, dents, or cuts that have been made to the surface of the support structure that would enhance the composite's grip to the support structure. FIG. 3C shows a support structure with purposefully drilled, formed, or made holes that would allow space for the composite to fill voids within the support structure before solidifying, enhancing the composite's ability to grip the support structure.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps, designs, materials, and the like in an unnecessary fashion. Nevertheless, the specification and claims should be read with the understanding that such combinations are entirely within the scope of the invention and the claims.

New plant support and supplement supplying devices, apparatuses, and methods are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

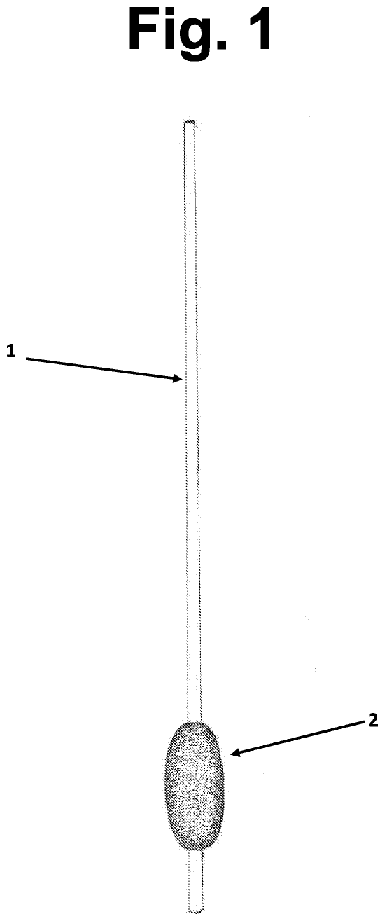

The present invention will now be described by referencing the appended figures representing preferred embodiments. FIG. 1 depicts the stand-alone integrated device composed of the support structure referenced by arrow 1 and the degradable fertilizer, pesticide, microorganism, and any additional chemicals and compounds used to enhance plant growth composite referenced by arrow 2. The support structure is one non-separable unit made up of a sturdy weather resistant material that is rigid enough to be driven vertically into the ground, support itself under its own weight once driven into the ground, as well as a be able to support the weight of the intended plant without noticeable or detrimental bending that would result in a structural failure. Materials that the support structure could be made of are, but are not limited to wood, bamboo, hardened plastics and polymers, metal alloys, aluminum, fiberglass, and various composites made out of plastics or organic materials like cellulose, held together by bonding agents.

The support structure would always exist as a device that is taller than it is wide, with part of the structure meant to be plunged underground and provide a space for attachment for the degradable composite. The geometric dimensions of the support structure depicted in FIG. 1 represented by arrow 1 can vary in specification through examples like but are not limited to, resembling a cylindrical dowel of equal diameter the entire length of the structure, tapered cylinders that contain different diameters throughout the length of the support structure, and cylinders with pointed or semi-pointed ends that exist at the bottom of the structure near the degradable composite for easier insertion into the ground. The three-dimensional shape of the structure could also include pyramidal, rectangular, and any other multisided shape that would allow for the support of the vertical height of the structure. Tapers, differing widths, and formed points could also be incorporated into the design of these geometric variations. Differing heights and widths of these structures can be used in infinite combinations, as long as the measurements allow for practical support for the plant within its environment.

The degradable composite referenced by arrow 2 is positioned and attached to the lower half of the support structure and is meant to exist underground along with the lower section of the support structure which is intended to act as an anchor for the vertical height of the rest of the structure. The degradable composite can comprise of slow or quick release fertilizers that have identifiable nitrogen, potassium, phosphorus, and any other beneficial material, mineral, or nutrient meant to promote plant growth, either synthetically made or naturally derived; systemic or non-systemic pesticides that are either synthetically made or naturally derived; and material inoculated with any microorganisms intended to be used for the benefit of the plant. Variations of the degradable composite can consist of composites of any of the items listed above by themselves, or any combination or grouping of each, depending on user want and need. The composite may be positioned and secured in full volume at any length of the support structure, allowing for parts of the structure to be seen protruding from both ends, or exist as a mass at the very base of the structure, and may be formed and molded around the base of the support structure in any shape that would best suit manufacturing and use. The whole volume of the composite is intended to exist below the soil level but may protrude above depending on user handling and preference.

Approaches to incorporating these separate materials to the base of the support structure could be through but are not limited to mixing the dry degradable composite ingredients together with a degradable, non-toxic liquid bonding agent that could be poured into a mold that surrounds the base of the support structure. The mold would be removed once the material had hardened leaving behind a finished device that had the composite firmly secured to the base of the structure. Another method for making the device could be through hard pressing the dry and or wet ingredients together to the base of the support structure, using pressure and friction to create a hardened composite that was secured and inseparable from the support structure. The composites can incorporate a neutral material like saw dust, sand, or other like materials to act as a filler for the composite helping to create mass and hold everything together. Preferred methods would use any combination or like method for securing the separate components of the composite to the base of the support structure.

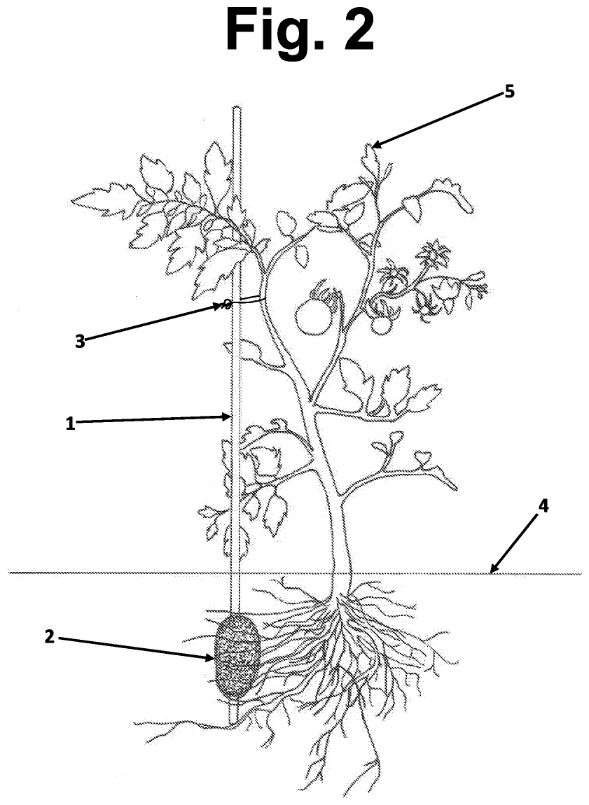

FIG. 2 depicts the device in use along side a plant. As seen in FIG. 2, the support structure (arrow 1) is in close enough proximity so that the plant (arrow 5) can be efficiently attached using materials like but not limited to string, yarn, metal, or plastic twist-ties (arrow 3). The plant can be secured to the above ground portion of the support device once or multiple times depending on the preference and determined support needs of the user. FIG. 2 shows the part of the support structure that is below the soil line (arrow 4) has the degradable composite (arrow 2) secured to it, existing in unison underground. The degradable composite (arrow 2) is close enough to the plant so that the roots of the plant can efficiently access the nutrients, chemicals, and other biological matter the composite slowly gives off into the soil allowing the plant to benefit from the existence of the device. Preferred embodiments of the device could include multiple support structures, connected by horizontal units that form trellis or cage like structures for the plant to attach to with some or every intermittent underground structure unit containing an incorporated degradable composite.

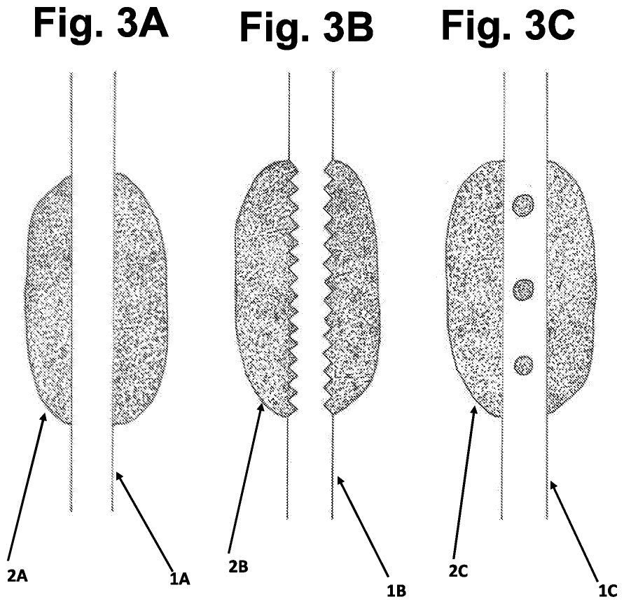

FIGS. 3A-C show three non-limiting examples of cross sections of the support structure and degradable composite and how alterations can be made to the support structure base to better facilitate attachment of the composite. FIG. 3A shows a cross section of the degradable composite (arrow 2A) affixed to the support structure (arrow 1A) through either or both friction and binding agents, with no alterations done to the support structure. FIG. 3B shows grooves that have been cut or pressed into the support structure (arrow 1B) that allows for the volume of the degradable composite (arrow 2B) to solidify and bite into the support structure allowing for better attachment. FIG. 3C shows holes that have been made into the support structure (arrow 1C) and the degradable composite (arrow 2C) has filled the empty voids allowing for the composite to have a better mode of attachment to the support structure. Preferred embodiments of the device would use any combination or like method for better securing the composite to the support structure.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A plant structural support and supplement delivery device, comprising:
a. A stake positional proximate a plant, said stake being made of material rigid enough to be driven into soil proximate said plant, said stake having an upper portion and lower portion, said lower portion hosting an integrally attached hardened composite, said composite having a formed shape enabling introduction of said lower portion into said soil, said upper portion providing surface area above the soil line to attach said plant.

2. The device of claim 1, wherein said composite is composed of various amounts of nutrients, chemicals, and biomass known to supplement plant growth.

3. The device of claim 1, wherein said composite degrades over time releasing its contents into the soil.

4. The device of claim 1, wherein said composite is made by the combining of said plant supplements with a liquid or gel binding agent and forming the mixture around said stake.

5. The device of claim 1, wherein said composite is formed through the binding of said plant supplements with pressure and friction around said stake.

6. The device of claim 1, wherein said lower portion of said stake contains holes, ridges, or a combination of the two allowing the composite to better affix to said stake through the method of either claim 4 or 5.
